(19) United States
(12) Patent Application Publication
(10) Pub. No.: US 2015/0307764 A1
(43) Pub. Date: Oct. 29, 2015

(54) THERMALLY CONDUCTIVE PLASTIC

(71) Applicant: QUARZWERKE GMBH, Frechen (DE)

(72) Inventors: Dirk Kruber, Alfter (DE); Michael Klawa, Burscheid (DE); Thorsten Hilgers, Kerpen (DE); Robert Szilluweit, Frechen (DE)

(21) Appl. No.: 14/653,660

(22) PCT Filed: Dec. 18, 2013
(86) PCT No.: PCT/EP2013/077066

§ 371 Date: Jun. 18, 2015

(30) Foreign Application Priority Data
Dec. 18, 2012 (EP) 12197839.9
Sep. 2, 2013 (EP) 13182652.1

(51) Int. Cl. C09K 5/14

(52) U.S. Cl. CPC C09K 5/14

(57) ABSTRACT

Disclosed is a composition containing a plastic and 20 to 80 wt % of an additive selected from among orthosilicates, metal silicon, and mixtures thereof.

The present invention relates to a thermally conductive plastic material.

Plastic materials are widespread materials for various applications. Plastic materials are characterized by good formability, good insulation performance, and acceptable strengths.

Plastic materials typically exhibit a low thermal conductivity. Typical thermal conductivities of plastic materials are within a range of from about 0.2 to 0.3 W/mK.

In principle, it is known to fill plastic materials with other materials to alter their properties. Numerous materials are suitable for this purpose. For example, boron nitrides are employed to influence the thermal conductivity, which, when used to fill the plastic material, can increase the thermal conductivity to more than double. The fillers used for increasing the conductivity are added in relatively large amounts, so that the price plays an important role in addition to the mechanical properties, the color, density, etc.

It is the object of the present invention to provide fillers for achieving desirable properties in a plastic composition.

This object is achieved by a thermally conductive composition comprising a plastic material and from 20 to 80% by weight of an additive selected from nesosilicates, metallic silicon, and mixtures thereof.

Thus, according to the invention, a plastic material is mixed with an additive selected from nesosilicates or metallic silicon or mixtures thereof and contained in an amount of from 20 to 80% by weight of the composition. Amounts of from 30 to 80% by weight are preferred. In addition, the composition contains a plastic material that accounts for the major part of the remaining composition. The amount of plastic material is preferably within a range of from 15 to 70%. In addition to the plastic material, other auxiliaries, especially colorants, impact modifiers etc., may also be present.

In one embodiment of the invention, the nesosilicates are aluminosilicates, especially alumosilicates. One particularly preferred nesosilicate is disthene.

The term “nesosilicates” is used to designate silicates whose silicate anions consist of isolated SiO₄ tetrahedra, i.e., the SiO₄ tetrahedra are not interconnected through Si—O—Si linkages.

This division of silicates includes the important rock forming minerals of the garnet and olivine groups, zircon, and the economically or petrologically important alumosilicates andalusite, sillimanite, disthene, and staurolite and topaz.

The simple structure of the SiO₄ polyatomic anion results in the absence of a pronounced anisotropy of the properties of nesosilicates. They are often cubic, tetragonal, trigonal, hexagonal or orthorhombic, and mostly form isometric crystals. The minerals of this division are mostly hard and have a high refractive index, and a relatively high density.

Suitable plastic materials include elastomers, thermoplastic or thermoset polymers, especially plastic materials selected from polyamide, polyethylene, polypropylene, polystyrene, polycarbonate, polyester, polyurethane, epoxy resins, and mixtures and copolymers thereof.

Copolymers include variants in which prepolymers or monomers with different basic chemical structures are polymerized together. They also include mixtures of more than two substances, also referred to as terpolymers.

In a particularly preferred embodiment, a combination of additives is employed, for example, different nesosilicates, or a mixture of a nesosilicate and metallic silicon, or else, for example, more than two different nesosilicates can be mixed, or several nesosilicates can be mixed with metallic silicon.

Suitable grain sizes of the additives are within a range of from about 1 to 50 μm (d50). “d50” means that 50% by weight of the grains have a grain size smaller than this value, and 50% by weight have a larger one. Such grain size characteristics can be established by laser diffraction. d50 grain sizes of at least 2 μm or at least 5 μm are preferred. The d50 grain size is preferably below 40 or below 30 μm. In some embodiments, the grain size is from 2 to 20 μm, in others from 10 to 30 μm, or from 10 to 50 μm.

In a preferred embodiment, the grains show a relatively narrow grain size distribution, so that d90/d50≦3 or ≦2.

The invention also relates to a process for preparing a thermally conductive composition according to the invention, comprising the step of mixing a plastic material with from 20 to 80% by weight, preferably from 30 to 80% by weight, of at least one additive selected from nesosilicates, metallic silicon, and mixtures thereof.

In some embodiments of the invention, the proportion of fillers employed according to the invention is 40% by weight or more, 50% by weight or more, or 60% by weight or more.

The invention further relates to the use of an additive selected from nesosilicates, metallic silicon, and mixtures thereof, for improving the thermal conductivity of a plastic material.

### EXAMPLES

1. Fillers Employed

| | | | | | Boron |
|---|---|---|---|---|---|
| Granulometric | Disthene | Disthene | Disthene | Silicon | nitride |
| data [μm] | sample 1 | sample 2 | sample 3 | (Si) | (BN) |
| d10 | 0.8 | 1.5 | 3.5 | 0.9 | 0.7 |
| d50 | 5 | 10 | 23 | 2.5 | 5 |
| d90 | 16 | 20 | 50 | 8 | 12 |

TREFIL 283-400 AST (Quarzwerke): wollastonite, d50 of about 5 μm

SILBOND 4000 AST (Quarzwerke): cristobalite, d50 of about 5 μm

TREMICA 1155-010 AST (Quarzwerke): muscovite, d50 of about 5 μm

Boron nitride, TREFIL, SILBOND and TREMICA were employed as comparative materials.

2. Preparation of the Filled Plastic Materials

In the case of the thermoplastic materials, the filler was compounded into polycaprolactam (PA6) through an extruder (Leistritz, ZSE 27 MAXX). From the compounds, molded parts were prepared by injection molding (Demag, Ergotech 100/420-310):

Multi purpose test specimen (ISO 3167 type A)

Sheet of 80 mm*80 mm*2 mm

The test specimens required for measuring the thermal conductivity were machined from the sheets. For measurement transverse to the direction of extrusion (Z direction), disks with d=12.7 mm were prepared by turning from the central position of the sheets. For determining the thermal conductivity in the direction of injection (X direction), 6 rods each with 12.7 mm length and 2 mm width had to be milled out, which were then clamped together, rotated by 90°, in a special sample holder for measurement. For thermosetting polymers, the fillers were incorporated into epoxy resins (Huntsman, Araldite CY 184, Aradur HY 1235, accelerator DY 062) by means of a vacuum mixer (PC-Laborsysteme, Labotop). The molding compositions were molded into sheets of dimensions 250 mm×250 mm×250 mm, and thermally cured. From these parts, test specimens with dimensions of about 20 mm×20 mm×2 mm were sawed out.

3. Measurements

On the thus prepared test specimens, mechanical properties and thermal conductivity were measured.

The following values for thermal conductivity in PA 6 (LFA 447 NanoFlash®, Netzsch) were obtained:

| | | | Z direction | X direction |
|---|---|---|---|---|
| | Filler | | Therm. | Therm. |
| | content | Density | Cond. | Cond. |
| Filler | [mass %] | [g/cm³] | [W/m K] | [W/m K] |
| Disthene sample 1 | 65 | 1.997 | 1.2 | 1.3 |
| | 70 | 2.092 | 0.9 | 1.6 |
| | 75 | 2.263 | 1.3 | 2.0 |
| Disthene sample 2 | 65 | 1.994 | 1.0 | 1.3 |
| | 70 | 2.086 | 1.1 | 1.5 |
| | 75 | 2.234 | 1.3 | 1.8 |
| Disthene sample 3 | 65 | 2.004 | 0.9 | 1.5 |
| | 70 | 2.139 | 1.3 | 1.8 |
| | 75 | 2.525 | 1.3 | 2.3 |
| TREFIL 283-400 AST | 65 | 1.837 | 0.6 | 1.0 |
| SILBOND 4000 AST | 65 | 1.676 | 1.1 | 1.1 |
| TREMICA 1155-010 | 65 | 1.800 | 0.4 | 1.2 |
| AST | | | | |
| PA6 | 0 | 1.140 | 0.3 | 0.3 |

Of the following mixtures, the thermal conductivity was measured only for individual filler contents:

| | | Thermal conductivity λ |
|---|---|---|
| Mixtures | Filler content | Z direction [W/mK] |
| PA6 + disthene 1; 37%/Si | 50 | 0.9 |
| 9%/BN 1% | | |
| PA6 + Si | 50 | 1.1 |
| PA6 + BN | 40 | 0.9 |

The data show that high filler contents and coarser fillers (higher d50 values) yield better thermal conductivities, which are significantly better than those of the comparative materials. As compared to cristobalite, the nesosilicate according to the invention is clearly softer (lower Mohs hardness), which results in a clearly reduced wear at the equipment employed, for example, compounders.

The following are the mechanical data for the disthene-containing samples in PA6 (universal tensile testing machine Zwick/Roell Z 202; pendulum impact tester Zwick/Roell HIT 25P):

| | | Tensile properties | | |
|---|---|---|---|---|
| | | Tensile | Elongation | Modulus of |
| | Filler content | strength | at break | elasticity |
| Product | [%] | [MPa] | [%] | [MPa] |
| Disthene sample 1 | 65 | 93.7 | 3.7 | 10,000 |
| | 70 | 94.2 | 3.3 | 11,300 |
| | 75 | 95.5 | 2.5 | 15,500 |
| Disthene sample 2 | 65 | 96.7 | 3.8 | 11,000 |
| | 70 | 95.8 | 3.2 | 12,700 |
| | 75 | 95.8 | 2.5 | 15,700 |
| Disthene sample 3 | 65 | 92.2 | 3.4 | 11,100 |
| | 70 | 93.7 | 3 | 13,500 |
| | 75 | 94.7 | 2.5 | 16,300 |
| PA6 | 0 | 85 | 8.4 | 3,210 |

| | Filler | Impact strength | Notched impact |
|---|---|---|---|
| Product | content [%] | [kJ/m²] | strength [kJ/m²] |
| | | Charpy pendulum impact tests | |
| Disthene sample 1 | 65 | 42.16 | 3.1 |
| | 70 | 37.04 | 2.76 |
| | 75 | 19.74 | 2.5 |
| Disthene sample 2 | 65 | 44.36 | 3.07 |
| | 70 | 34.16 | 2.82 |
| | 75 | 20.97 | 2.5 |
| Disthene sample 3 | 65 | 37.81 | 2.93 |
| | 70 | 30.69 | 3.18 |
| | 75 | 24.25 | 2.85 |
| PA6 | 0 | no break | 5.5 |
| | | Izod pendulum impact tests | |
| Disthene sample 1 | 65 | 34.52 | 3.25 |
| | 70 | 30.43 | 3.22 |
| | 75 | 20 | 3.24 |
| Disthene sample 2 | 65 | 34.35 | 3.34 |
| | 70 | 28.7 | 3.38 |
| | 75 | 19.18 | 3.26 |
| Disthene sample 3 | 65 | 30.62 | 3.45 |
| | 70 | 24.05 | 3.72 |
| | 75 | 20.09 | 3.7 |
| PA6 | 0 | 107 | 2.5 |

Despite the high filler contents, the materials according to the invention show good mechanical properties. The finer the filler (the smaller the d50), the better the mechanical properties.

| | | Heat deflection temperature |
|---|---|---|
| Product | Filler content [%] | (ISO 75 HDT/A (1.8 MPa) ° C. |
| Disthene sample 1 | 65 | 142.45 |
| | 70 | 143.73 |
| | 75 | 164.38 |
| Disthene sample 2 | 65 | 151.25 |
| | 70 | 157.25 |
| | 75 | 166.86 |
| Disthene sample 3 | 65 | 150.49 |
| | 70 | 165.0 |
| | 75 | 172.7 |
| PA6 | 0 | 75 |

The plastic materials filled according to the invention show excellent heat deflection temperatures.

A thermoset mixture of 63% by weight disthene and 37% by weight epoxy resin had the following properties:

Mechanical properties

| | | |
|---|---|---|
| Modulus of elasticity [MPa] | ISO 178 | 11,500 |
| Tensile stress at break [MPa] | ISO 178 | 108 |
| Elongation at break [%] | ISO 178 | 1.06 |
| Impact strength [kJ/m²] | ISO 179/1 eU | 7.10 |
| (Charpy) | | |

Electrical properties

| | | |
|---|---|---|
| Sheet resistivity [Ω per square] | DIN IEC 167 | >10¹³ |

Thermal properties

| | | |
|---|---|---|
| Thermal conductivity [W/mK] | )* | 1.35 |

)* measured with NanoFlash

In comparison, the unfilled thermoset material (100% epoxy resin) has a thermal conductivity of only 0.2 W/mK.

SEM Analysis

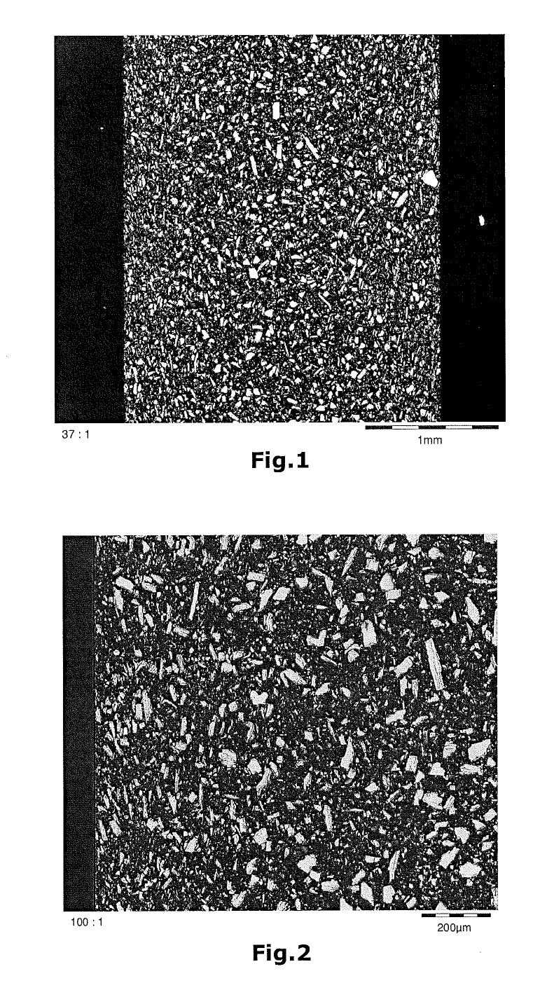

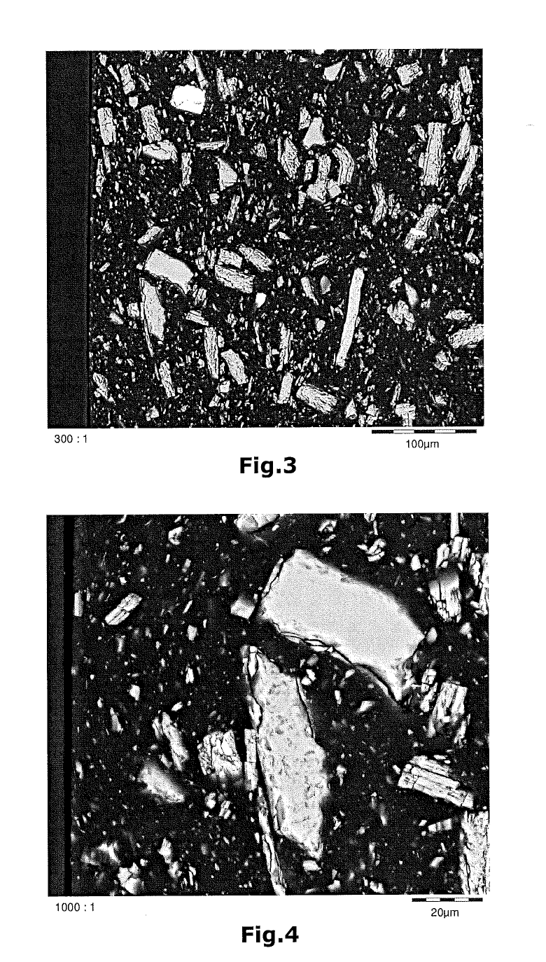

The materials were examined by scanning electron microscopy (Joel JSM 7600F). FIGS. 1 to 4 show micrographs of PA6 and disthene sample 3 (60% by weight) in different magnitudes.

It is found that the materials, although not achieving any bonding within the material, nevertheless exhibit good thermal conductivities.

1. A composition comprising a plastic material and from 20 to 80% by weight of an additive selected from nesosilicates, metallic silicon, and mixtures thereof.

2. The composition according to claim 1, wherein said nesosilicates are aluminosilicates.

3. The composition according to claim 1, wherein said nesosilicate is disthene.

4. The composition according to claim 1, wherein said plastic material is an elastomer, thermoplastic or thermoset polymer.

5. The composition according to claim 1, wherein said plastic material is selected from polyamide, polyethylene, polypropylene, polystyrene, polycarbonate, polyester, polyurethane, epoxy resins, and mixtures and copolymers thereof.

6. The composition according to claim 1, wherein several additives are employed in combination said additive is a mixture.

7. The composition according to claim 1, wherein the grain size (d50) of the additive is within a range of from 1 to 50 μm.

8. The composition according to claim 1, wherein said additive is silanized.

9. A process for preparing a composition according to claim 1, comprising the step of mixing a plastic material with from 20 to 80% by weight of at least one additive selected from nesosilicates, metallic silicon, or mixtures thereof.

10. The method for improving the thermal conductivity of plastic materials comprising the step of adding an additive selected from nesosilicates, metallic silicon, or mixtures thereof.

11. The composition according to claim 2, wherein said aluminosilicates are alumosilicates.
